(19) United States
(12) Patent Application Publication
(10) Pub. No.: US 2008/0004357 A1
(43) Pub. Date: Jan. 3, 2008

(54) Method of producing finely divided oil-in-water emulsions

(75) Inventors: Jurgen Meyer, Munster (DE); Ralph Scheuermann, Essen (DE); Joachim Venzmer, Essen (DE)

Correspondence Address: Leopold Presser, Scully, Scott, Murphy & Presser, 400 Garden City Plaza, Garden City, NY, 11530, US

(73) Assignee: Goldschmidt GmbH, Essen (DE)

(21) Appl. No.: 11/820,649

(22) Filed: Jun. 20, 2007

(30) Foreign Application Priority Data
Jul. 1, 2006 (DE) 10 2006 030 532.9

(51) Int. Cl. B01F 3/08

(52) U.S. Cl. 516/54; 516/72

(57) ABSTRACT

The invention relates to a method of producing finely divided oil-in-water emulsions which comprise oil, water and at least one emulsifier, which comprises a step
A) producing a mixture 2, which has oil, water, at least one emulsifier and at least one cosmotropic substance, by mixing oil, water, at least one emulsifier and at least one cosmotropic substance, where the phase inversion temperature PIT2 of this mixture (Winsor IV system) is less than the phase inversion temperature PIT1 of a mixture 1 (Winsor IV system) which has no cosmotropic substances and otherwise the same composition as mixture 2,
   and subsequently a step
B) addition of a diluent to mixture 2 to convert this mixture to an emulsion 3, where the amount of added diluent is chosen so that the resulting emulsion 3 at a pregiven temperature is not in the Winsor IV phase region.

### FIELD OF THE INVENTION

The present invention relates to methods of producing finely divided oil-in-water emulsions. More particularly, the present invention relates to methods in which the phase inversion temperature (PIT) of a particular system is influenced by adding cosmotropic substances.

### BACKGROUND OF THE INVENTION

In certain areas of application, oil-in-water (O/W) emulsions are preferably used both for cosmetic, dermatological and pharmaceutical formulations, and also in aqueous formulations for household and industry applications.

The conventionally produced emulsions have droplet sizes in the μm region and consequently have the disadvantage that they are not stable, i.e., the prior art emulsions have a tendency for phase separation, without the addition of additional stabilizers. For this reason, using conventional methods, emulsions with long-term stability and low viscosity, in particular, can only be produced very occasionally.

One alternative is thermodynamically stable microemulsions. Although such microemulsions are stable to separation, they only exist in narrow concentration and temperature ranges which are not adequate for all areas of application.

The emulsions produced by a phase inversion temperature method (PIT method) (K. Shinoda, H. Kunieda; Encyclopedia of Emulsion Technology; Vol. 1 (1983), 337-367) are likewise extremely finely divided, i.e., on account of their droplet sizes in the range from about 20 to 200 nm, they ensure excellent stability in large temperature and concentration ranges.

In the PIT method, the following processes occur according to current model concepts:

At room temperature, oil, water and emulsifiers form a two-phase mixture comprising an O/W microemulsion and an oil phase (Winsor I type, W I).

To achieve a single-phase region (Winsor IV type, W IV), increasing the emulsifier concentration is by itself not sufficient; increasing the temperature is necessarily required. At a system-dependent minimum temperature of the phase inversion temperature (PIT), a bicontinuous, homogeneous mixed phase (Winsor IV type) forms in which phase inversion from O/W to W/O takes place.

Upon further increasing the temperature, the homogeneous Winsor IV system converts to a two-phase Winsor II system (W II) in which a W/O microemulsion is in equilibrium with an excess water phase.

In the art, use is now made of the fact that, upon very rapid cooling, a microemulsion of the type W IV can form which, following phase inversion to O/W, is then virtually “frozen”, meaning that further conversion to the type W I does not occur.

Thus, extremely stable finely divided emulsion concentrates are obtained which are dilutable with water to an unlimited degree.

The PIT method was hitherto the only way of producing such emulsions also on an industrial scale.

It is disadvantageous that, in the aforementioned PIT method, the mixture of the components has to be heated above the phase inversion temperature in order to convert the O/W emulsion present at room temperature to a W/O emulsion and to produce a finely divided O/W emulsion through subsequent cooling. The required energy input for heating and effective cooling is considerable and uneconomic.

There is therefore a need for a cost-effective method of producing finely divided emulsions which have excellent stability in wide temperature and concentration ranges.

### SUMMARY OF THE INVENTION

The present invention provides a cost-effective method of producing finely divided emulsions which avoids the drawbacks mentioned with prior art PIT methods. The invention method includes, in a first stage, the lowering of the so-called phase inversion temperature (PIT) through the use of cosmotropic substances at least to the level of room temperature or the application temperature and, in a second stage, the temperature is increased again, preferably to the original level, by adding diluents.

In this method, the cosmotropic substances replace the step of increasing the temperature.

By adding sufficient amounts of diluents, according to the invention preferably water or aqueous, optionally alcoholic solutions, the minimum concentration of the cosmotropic substances (CS) required for lowering the phase inversion temperature is not reached, meaning that the original temperature therefore is restored. The dilution takes place so rapidly that—similarly to the rapid temperature lowering—no conversion of the emulsion to the Winsor type W I takes place.

Since this method is thus essentially based on a deactivation of the cosmotropic substances (“quenching”), it is possible, in accordance with the temperature-controlled PIT method, to talk in the present case of a PSQ method (phase shift by quenching).

The invention therefore provides a method of producing finely divided oil-in-water emulsions which comprise oil, water and at least one emulsifier, and which are preferably kinetically stable at ambient temperature, processing temperature or use temperature, which comprises:
A) producing a mixture 2, which contains oil, water, at least one emulsifier and at least one cosmotropic substance, by mixing oil, water, at least one emulsifier and at least one cosmotropic substance, where the phase inversion temperature PIT2 of this mixture (Winsor IV system) is less than the phase inversion temperature PIT1 of a mixture 1 (Winsor IV system) which has no cosmotropic substances and otherwise the same composition as mixture 2, and
B) addition of a diluent to mixture 2 to convert this mixture to an emulsion 3, where the amount of added diluent is chosen so that the resulting emulsion 3 at a pregiven temperature is not in the Winsor IV phase region.

In the method according to the invention, preference is given to producing a finely divided oil-in-water emulsion 3 which has an average particle size of less than 1 μm, preferably from 10 to 500 nm, particularly preferably from 15 to 300 nm and very particularly preferably from 60 to 200 nm.

### BRIEF DESCRIPTION OF THE DRAWINGS

FIG. 1 is a graph plotting the intensity vs. radius of the O/W emulsion of Example 1 as measured by dynamic light scattering.

FIG. 2 is a graph plotting the intensity vs. radius of the O/W emulsions of Example 2a (filled symbols, solid curve) and Example 2b (open symbols, dashed curve) as determined by dynamic light scattering.

FIGS. 3A and 3B are light micrographs of the O/W emulsions produced in step 2 of Examples 2a and 2b, respectively.

### DETAILED DESCRIPTION OF THE INVENTION

As stated above, the present invention provides a method for producing finely divided O/W emulsions wherein, in a first stage, the so-called phase inversion temperature (PIT) is lowered through the use of cosmotropic substances at least to the level of room temperature or the application temperature and, in a second stage, the temperature is increased again, preferably to the original level, by adding diluents.

More particularly, the present method includes the steps of:
A) producing a mixture 2, which contains oil, water, at least one emulsifier and at least one cosmotropic substance, by mixing oil, water, at least one emulsifier and at least one cosmotropic substance, where the phase inversion temperature PIT2 of this mixture (Winsor IV system) is less than the phase inversion temperature PIT1 of a mixture 1 (Winsor IV system) which has no cosmotropic substances and otherwise the same composition as mixture 2,
B) addition of a diluent to mixture 2 to convert this mixture to an emulsion 3, where the amount of added diluent is chosen so that the resulting emulsion 3 at a pregiven temperature is not in the Winsor IV phase region

As stated above, the method produces a finely divided oil-in-water emulsion 3 which has an average particle size of less than 1 μm, preferably from 10 to 500 nm, particularly preferably from 15 to 300 nm and very particularly preferably from 60 to 200 nm.

As mixture 2, a microemulsion is preferably produced in the method according to the invention.

In step B) of the method according to the invention, preferably at least 1, preferably at least 5 and particularly preferably at least 10, parts by mass of diluent are added to 1 part by mass of the mixture 2.

In the method according to the invention, in step B), the amount of diluent added is preferably such that the transition temperature at which the emulsion 3 converts to the Winsor IV phase region is at least 1 K, preferably 10 K, particularly preferably 40 K, above the ambient temperature, the processing temperature or use temperature.

Diluents which can be used in step B) are, for example, water or an aqueous solution.

One variant of the method according to the invention for producing the finely divided oil-in-water emulsions consists in producing an emulsion kinetically stable at ambient temperature, processing temperature or use temperature as emulsion 3, where, in step A), a thermodynamically stable and macroscopically homogeneous mixture of water, oil, at least one emulsifier and at least one cosmotropic substances is produced by customary methods, and where step A) is carried out at a temperature which is lower than the phase inversion temperature PIT1 of the mixture 1 without addition of the cosmotropic substances.

A further variant of the method according to the invention for producing the finely divided oil-in-water emulsions consists in producing an emulsion kinetically stable at ambient temperature, processing temperature or use temperature as emulsion 3, where step A) comprises the admixing of at least an amount of at least one cosmotropic substance to a mixture 1, which comprises oil, water and at least one emulsifier and which has a phase inversion temperature PIT1 (Winsor IV system), such that a mixture 2 is obtained whose phase inversion temperature (Winsor IV system) PIT2 is less than PIT1.

A further variant of the method according to the invention for producing the finely divided oil-in-water emulsions consists in producing an emulsion kinetically stable at ambient temperature, processing temperature or use temperature as emulsion 3, where, in step A), water, oil, at least one emulsifier and at least one cosmotropic substance are used to produce a W/O microemulsion phase in equilibrium with excess water phase (type W II) by customary methods without exceeding the original phase inversion temperature.

As explained, the cosmotropic substance brings about the lowering of the phase inversion temperature. The extent of lowering is dependent on the nature and the amount of the cosmotropic substance employed in the present invention. It has been found that lowering the phase inversion temperature is essentially proportional to the amount used.

Since in the second step of the method the influence of the cosmotropic substance is diminished again through dilution with, in particular, water, it is possible, in each individual case, to determine the optimum amount by exploratory experiments. According to the invention, optimum amount means either an amount suitable in practice for adequately lowering the PIT, or a minimum amount suitable in practice of water for the rapid and targeted deactivation of the cosmotropic substances for increasing the PIT.

The invention further provides the use of the method according to the invention for producing emulsions in the manufacture of cosmetic, dermatological, pharmaceutical or agrochemical preparations, in the manufacture of impregnated wipes or in sprayable preparations for face care and body care, baby care, sun protection, make-up remover, antiperspirants/deodorants, in the manufacture of aqueous formulations for applications in the areas household, sport, leisure and industry, in the manufacture of impregnated wipes or in sprayable preparations for the cleaning and care of textiles, leather, plastics, metallic and nonmetallic surfaces, and in the manufacture of sprayable preparations of agrochemical formulations which comprise oils and optionally further active substances, such as pesticides.

For the purposes of the invention, the cosmotropic substances co-used according to the invention are, according to the definition, compounds which, according to the Hofmeister series, may be anions, cations, salts, or organic compounds with hydrophilic groups, in particular hydroxyl or carboxyl groups.

Anions are, for example, SO₄²⁻, PO₄³⁻, citrate, tartrate or acetate.

Cations are, for example, Al³⁺, Mg²⁺, Ca²⁺, Ba²⁺, Li⁺, Na⁺ or K⁺.

Salts are, for example, sodium citrate, Na₂SO₄, (NH₄)₂SO₄, NaCl or NH₄SCN.

Organic compounds are, for example, mono- or polyhydric alcohols, such as butanol, glycerol, diglycerol triglycerol, sugars, sugar alcohols, sugar acids, hydroxycarboxylic acids, such as lactic acid, maleic acid, tartaric acid, citric acid or ascorbic acid.

These compounds can be co-used on their own or in combination with one another and/or among one another.

Amounts sufficient for lowering the phase inversion temperature are dependent on the type and amount of the oil component used in each case, of the emulsifier components and of the type of cosmotropic substances. As a rule, amounts in the range from 1 to 50% by weight, advantageously from 20 to 40% by weight, are adequate. The optimum amounts in each case can be ascertained by a few simple exploratory experiments.

Oils which can be used according to the invention are, in principle, all compounds suitable in cosmetics for producing cleansing and care aqueous emulsions, or mixtures thereof, such as mono- and diesters of mono-/dicarboxylic acids and mono-/dialcohols, for example of the general formula (I), (II) and (III)

R¹—COOR² (I)

R²—OOC—R³—COOR² (II)

R¹—COO—R³—OOC—R¹ (III)

in which

### R¹ is an alkyl group having 8 to 22 carbon atoms,

### R² is an alkyl group having 3 to 22 carbon atoms, and

### R³ is alkylene groups having 2 to 16 carbon atoms, with the proviso that the total number of carbon atoms in the compounds (I) to (III) is at least 11.

These compounds are known as cosmetic and pharmaceutical oil components. Among the mono- and diesters of this type, the products liquid at room temperature (20° C.) are of greatest importance. Monoesters (I) suitable as oil bodies are, for example the isopropyl esters of fatty acids having 12 to 22 carbon atoms, such as, for example, isopropyl myristate, isopropyl palmitate, isopropyl stearate, isopropyl oleate. Other suitable monoesters are, for example, n-butyl stearate, n-hexyl laurate, n-decyl oleate, isooctyl stearate, isononyl palmitate, isononyl isononanoate, 2-ethylhexyl palmitate, 2-ethylhexyl laurate, 2-hexyldecyl stearate, 2-octyldodecyl palmitate, oleyl oleate, oleyl erucate, erucyl oleate, and esters which are obtainable from technical-grade aliphatic alcohol mixtures and technical-grade aliphatic carboxylic acids, e.g., esters of saturated and unsaturated fatty alcohols having 12 to 22 carbon atoms and saturated and unsaturated fatty acids having 12 to 22 carbon atoms, as are accessible from animal and vegetable fats. Also suitable are naturally occurring monoester and wax ester mixtures, as are present, for example, in jojoba oil or in sperm oil.

Suitable dicarboxylic acid esters (II) are, for example, di-n-butyl adipate, di-n-butyl sebacate, di(2-ethylhexyl)adipate, di(2-hexyldecyl)succinate and diisotridecyl azelate. Suitable diol esters (III) are, for example, ethylene glycol dioleate, ethylene glycol diisotridecanoate, propylene glycol di(2-ethylhexanoate), propylene glycol diisostearate, propylene-45 glycol dipelargonate, butanediol diisostearate and neopentyl glycol dicaprylate.

Highly suitable oil bodies are also esters of tri- and polyhydric alcohols, in particular vegetable triglycerides, e.g., olive oil, almond oil, peanut oil, sunflower oil or also the esters of pentaerythritol with, for example, pelargonic acid or oleic acid.

Fatty acid triglycerides which can be used are natural, vegetable oils, e.g., olive oil, sunflower oil, soya oil, peanut oil, rapeseed oil, almond oil, palm oil, but also the liquid fractions of coconut oil or of palm kernel oil, and animal oils, such as, for example, neatsfoot oil, the liquid fractions of beef tallow, or else synthetic triglycerides, as are obtained by esterification of glycerol with fatty acids having 8 to 22 carbon atoms, e.g., triglycerides of caprylic acid/capric acid mixtures, triglycerides from technical-grade oleic acid or from palmitic acid/oleic acid mixtures.

Preferably suitable as oil components for the method according to the invention are those mono- and diesters and triglycerides which are liquid at a standard temperature of 20° C. However, it is also possible to use higher-melting fats and esters which correspond to the stated formulae in amounts such that the mixture of the oil components remain liquid at standard temperature.

The oil component can also comprise hydrocarbon oils in secondary amounts up to at most 25% by weight-based on the oil component. Suitable hydrocarbons are in particular paraffin oils and synthetically produced hydrocarbons, e.g., liquid polyolefins or defined hydrocarbons, e.g., alkylcyclohexanes, such as, for example, 1,3-diisooctylcyclohexane.

Preference is given to esters of linear C₈-C₁₈-fatty acids with linear or branched C₆-C₂₂-fatty alcohols and esters of branched C₂-C₁₃-carboxylic acids with linear or branched C₆-C₂₂-fatty alcohols, such as, for example myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate.

Also suitable are esters of linear C₆-C₂₂-fatty acids with branched alcohols, in particular 2-ethylhexanol, esters of C₁₈-C₃₆-alkylhydroxycarboxylic acids with linear or branched C₆-C₂₂-fatty alcohols, in particular dioctyl malates, esters of linear and/or branched fatty acids with polyhydric alcohols (such as, for example, propylene glycol, dimerdiol or trimertriol) and/or Guerbet alcohols, triglycerides based on C₆-C₁₈-fatty acids, liquid mono-/di-/triglyceride mixtures based on C₆-C₁₈-fatty acids, esters of C₆-C₂₂-fatty alcohols and/or Guerbet alcohols with aromatic carboxylic acids, in particular benzoic acid, esters of C₂-C₁₂-dicarboxylic acids with linear or branched alcohols having 1 to 22 carbon atoms or polyols having 2 to 10 carbon atoms and 2 to 6 hydroxyl groups, vegetable oils, branched primary alcohols, substituted cyclohexanes, linear and branched C₆-C₂₂-fatty alcohol carbonates, such as, for example, dicaprylyl carbonates, Guerbet carbonates based on fatty alcohols having 6 to 18, preferably 8 to 10, carbon atoms, such as, for example, diethylhexyl carbonate (Tegosoft® DEC, Goldschmidt GmbH), esters of benzoic acid with linear and/or branched C₆-C₂₂-alcohols, linear or branched, symmetrical or asymmetrical dialkyl ethers having 6 to 22 carbon atoms per alkyl group, such as, for example, dicaprylyl ether, ring-opening products of epoxidized fatty acid esters with polyols, and/or aliphatic or naphthenic hydrocarbons, such as, for example, squalane, squalene or dialkylcyclohexanes, silicone oils, such as cyclomethicones or dimethicones, also propoxylated fatty alcohols, such as PPG-15 stearyl ether, PPG-3-myristyl ether and PPG-14 butyl ether.

In principle, suitable emulsifiers are all compounds as are used in the prior art as emulsifiers for producing cosmetic O/W and W/O emulsions. Preference is given here to using at least one emulsifier selected from the group of ionic and nonionic emulsifiers.

Without laying claim to completeness, the following representatives may additionally be mentioned from the known classes of suitable emulsifier components:

Suitable nonionic emulsifiers here are particularly oligoalkoxylates of basic molecules containing lipophilic radicals. These can be derived in particular from selected representatives from the following classes of basic molecules containing lipophilic radicals: fatty alcohols, fatty acids, fatty amines, fatty amides, fatty acid and/or fatty alcohol esters and/or ethers, alkanolamides, alkylphenols and/or reaction products thereof with formaldehyde, and further reaction products of carrier molecules containing lipophilic radicals with lower alkoxides. As stated, the respective reaction products can also be at least proportionately end-capped. Examples of partial esters and/or partial ethers of polyfunctional alcohols are, in particular, the corresponding partial esters with fatty acids, for example of the glycerol mono- and/or diester type, glycol monoesters, corresponding partial esters of oligomerized polyfunctional alcohols, sorbitan partial esters and the like, and corresponding compounds with ether groups. Such partial esters and/or ethers can in particular also be basic molecules for an (oligo)alkoxylation.

In the alkoxylation, preference is given to using ethylene oxide, propylene oxide, butylene oxide or styrene oxide.

Particularly preferred nonionic alkoxylated emulsifiers are:

Addition products of from 2 to 30 mol of ethylene oxide and/or 0 to 5 mol of propylene oxide onto linear fatty alcohols having 8 to 22 carbon atoms, onto fatty acids having 12 to 22 carbon atoms and onto alkylphenols having 8 to 15 carbon atoms in the alkyl group; glycerol mono- and diesters and sorbitan mono- and diesters of saturated and unsaturated fatty acids having 6 to 22 carbon atoms and ethylene oxide addition products thereof; alkyl mono- and oligoglycosides having 8 to 22 carbon atoms in the alkyl radical and ethoxylated analogs thereof. The addition products of ethylene oxide and/or of propylene oxide onto fatty alcohols, fatty acids, alkylphenols, glycerol mono- and diesters, and sorbitan mono- and diesters of fatty acids or onto castor oil are known, commercially available products. These are homolog mixtures whose average degree of alkoxylation corresponds to the ratio of the amounts of ethylene oxide and/or propylene oxide and substrate with which the addition reaction is carried out; comb-like or terminally modified silicone polyethers, as are available, for example, through hydrosilylation reactions under known conditions through addition of alkene-functionalized polyethers with preferably 2 to 100 mol of ethylene oxide and/or propylene oxide. The terminal hydroxyl groups of such polyethers may here also be optionally alkyl-terminated (in particular methyl-terminated).

Furthermore, nonionic emulsifiers which may be used are also:

polyol and in particular polyglycerol esters, such as, for example, polyglycerol polyricinoleate or polyglycerol poly-12-hydroxystearate. Likewise suitable are mixtures of compounds from two or more of these classes;
partial esters based on linear, branched, unsaturated or saturated C₆₋₂₂-fatty acids, ricinoleic acid, and 12-hydroxystearic acid and glycerol, polyglycerol, pentaerythritol, dipentaerythritol, sugar alcohols (e.g., sorbitol), alkyl glucosides (e.g., methyl glucoside, butyl glucoside, lauryl glucoside), and polyglucosides (e.g., cellulose); polysiloxane-polyalkyl-polyether copolymers and corresponding derivatives; C_{8/18}-alkyl mono- and oligoglycosides, their production and their use as surface-active substances are known, for example, from U.S. Pat. No. 3,839,318, U.S. Pat. No. 3,707,535, U.S. Pat. No. 3,547,828, DE-A 19 43 689, DE-A 20 36 472 and DE-A130 01 064, and EP-A 0 077 167. Their production takes place in particular by reacting glucose or oligosaccharides with primary alcohols having 8 to 18 carbon atoms.

Suitable emulsifiers with ionic character are anionic, cationic and zwitterionic emulsifiers. Anionic emulsifiers contain water-solubilizing anionic groups, such as, for example, a carboxylate, sulfate, sulfonate or phosphate group, and a lipophilic radical. Skin-compatible anionic surfactants are known to the person skilled in the art in large numbers and are commercially available. These are in particular alkyl sulfates or alkyl phosphates in the form of their alkali metal, ammonium or alkanol ammonium salts, alkyl ether sulfates, alkyl ether carboxylates, acyl sarcosinates, and sulfosuccinates and acyl glutamates in the form of their alkali metal or ammonium salts. Di- and trialkyl phosphates, and mono-, di- and/or tri-PEG alkyl phosphates and salts thereof can also be used.

It is also possible to use cationic emulsifiers. As such, quaternary ammonium compounds in particular can be used, for example alkyltrimethylammonium halides, such as, for example, cetyltrimethylammonium chloride or bromide or behenyl trimethylammonium chloride, but also dialkyldimethylammonium halides, such as, for example, distearyldimethylammonium chloride. Furthermore, monoalkylamidoquats such as, for example, palmitamidopropyltrimethylammonium chloride or corresponding dialkylamidoquats can be used. Furthermore, it is possible to use readily biodegradable quaternary ester compounds, which are mostly quaternized fatty acid esters based on mono-, di- or triethanolamine. Furthermore, alkylguanidinium salts can be used as cationic emulsifiers.

Furthermore, zwitterionic surfactants can be used as emulsifiers. Zwitterionic surfactants is the term used to refer to those surface-active compounds which carry at least one quaternary ammonium group and at least one carboxylate group and one sulfonate group in the molecule. Particularly suitable zwitterionic surfactants are the so-called betaines, such as the N-alkyl-N,N-dimethylammonium glycinates, for example cocoalkyldimethylammonium glycinate, N-acylaminopropyl-N,N-dimethylammonium glycinates, for example cocoacylaminopropyldimethylammonium glycinate, and 2-alkyl-3-carboxymethyl-3-hydroxyethylimidazolines having in each case 8 to 18 carbon atoms in the alkyl or acyl group, and cocoacylaminoethyl hydroxyethylcarboxymethyl glycinate. Particular preference is given to the fatty acid amide derivative known under the CTFA name cocoamidopropylbetaine. Likewise suitable emulsifiers are ampholytic surfactants. Ampholytic surfactants are understood as meaning those surface-active compounds which, apart from a C_{8/18}-alkyl or -acyl group in the molecule, contain at least one free amino group and at least one —COOH or —SO₃H group and are capable of forming internal salts. Examples of suitable ampholytic surfactants are N-alkylglycines, N-alkylpropionic acids, N-alkylaminobutyric acids, N-alkyliminodipropionic acids, N-hydroxyethyl-N-alkylamidopropylglycines, N-alkyltaurines, N-alkylsarcosines, 2-alkylaminopropionic acids and alkylaminoacetic acids having in each case about 8 to 18 carbon atoms in the alkyl group. Particularly preferred ampholytic surfactants are N-cocoalkylaminopropionate, cocoacylaminoethylaminopropionate and C₁₂₋₁₈-acylsarcosine. Besides the ampholytic emulsifiers, quaternary emulsifiers are also suitable, where those of the ester quat type, preferably methyl-quaternized difatty acid triethanolamine ester salts, are particularly preferred.

Particular preference is given to the use of at least one alkoxylated nonionic emulsifier. This nonionic base emulsifier or the combination of two or more nonionic emulsifiers can be combined, in a particularly preferred embodiment of the invention, with ionic emulsifier components.

The amounts of co-used oils and emulsifiers are not critical for the present method and correspond to the formulations used in the relevant technical fields and are known to the person skilled in the art.

Besides the oils and emulsifiers mentioned, these emulsions can in this respect comprise customary auxiliaries and additives known to the person skilled in the art. These include, for example, consistency regulators, thickeners, waxes, UV photoprotective filters, antioxidants, hydrotropes, deodorant and antiperspirant active ingredients, insect repellents, self-tanning agents, preservatives, perfume oils, dyes, and biogenic or synthetic cosmetic active ingredients (as are described, for example, in the application DE 10 2005 003 164.1).

The following examples are provided to illustrate the present invention and to demonstrate some benefits that can be obtained when utilizing an O/W emulsion that is produced by the inventive method.

### EXAMPLE 1

### Sprayable Cosmetic Lotion

Step 1:

36 g of octyl palmitate (TEGOSOFT® OP, Goldschmidt GmbH), 24 g of a polyalcohol mixture having 12 to 14 carbon atoms, which carries on average 8 ethylene oxide units (C_{12/14}E₈), 10 g of water and 30 g of glycerol were combined and stirred. A homogeneous and transparent microemulsion phase which was a single phase at room temperature was formed, whose single-phase region (Winsor IV system) was in the temperature range between 19° C. and 31° C.

Step 2:

One part of the microemulsion phase was stirred at room temperature into five parts of water. A homogeneous, milky, finely divided O/W emulsion was formed. The emulsion obtained in this way was stable in the storage test at −15° C., −5° C., 5° C., room temperature and 40° C. for three months.

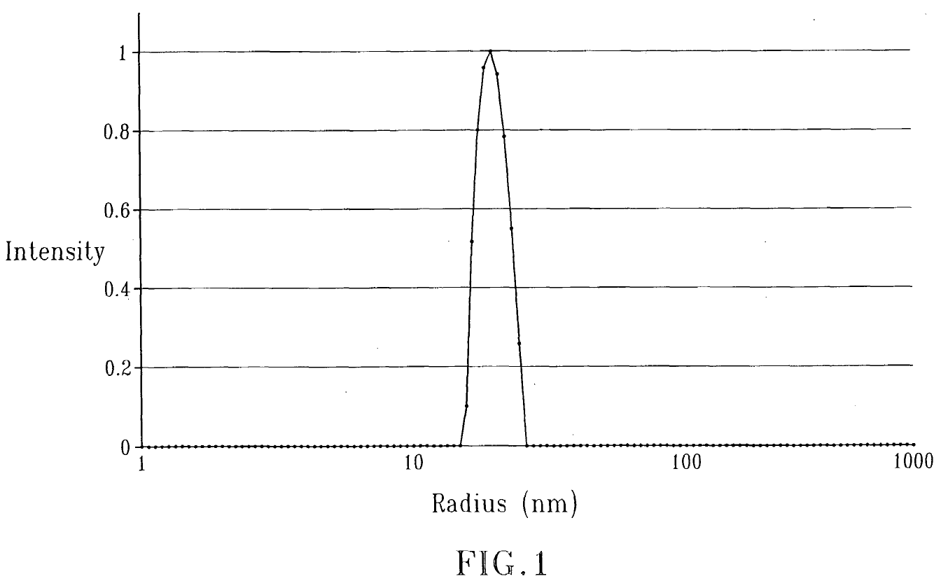

The droplet size of the O/W emulsion obtained in step 2 was determined using dynamic light scattering following dilution with a twenty-fold amount of water to an oil/surfactant concentration of 0.5%. FIG. 1 shows that a narrow distribution of the droplet radii was present between 15 nm and 25 nm with a maximum at 19 nm.

### EXAMPLE 2a

### Impregnation Lotion for Producing Cosmetic Wet Wipes

Step 1:

36 g of octyl palmitate (TEGOSOFT® OP, Goldschmidt GmbH), 27 g of C_{12/14}E₈, 12 g of water, 18 g of glycerol, 3 g of preservative (Euxyl® K 300, Schülke & Mayr (phenoxyethanol, methyl-, ethyl-, butyl-, propyl- and isobutylparaben)) and 3 g of trilaureth-4 phosphate (Hostaphat® KL 340 D, Clariant) were combined and stirred. A homogeneous and transparent microemulsion phase which was a single phase at room temperature was formed, whose single-phase region (Winsor IV system) was in the temperature range between 8° C. and 43° C.

Step 2:

The microemulsion phase was stirred at room temperature into a five times larger amount of water. A homogeneous, milky, finely divided O/W emulsion was formed.

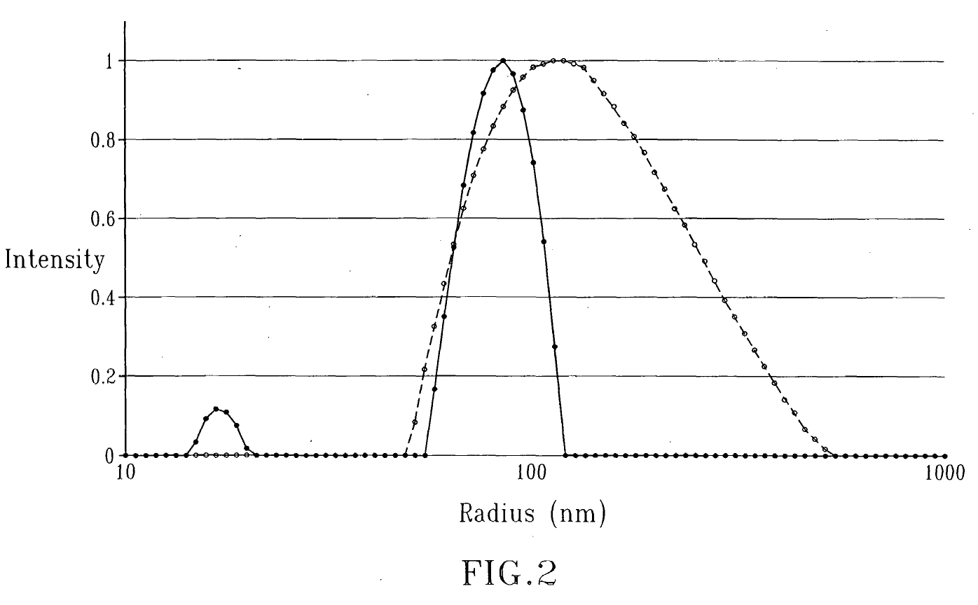

The droplet size of the O/W emulsion obtained in step 2 was determined by means of dynamic light scattering following dilution with a twenty-fold amount of water to an oil/surfactant concentration of about 0.5%. FIG. 2 shows that a narrow distribution of the droplet radii was present between 55 nm and 110 nm with a maximum at 82 nm. Excess emulsifier formed micelles whose radius was between 15 nm and 20 nm.

For comparison, in the following Example 2b an O/W emulsion was produced utilizing the PIT method described in Example 2a except no glycerol was employed.

### EXAMPLE 2b

Step 1:

36 g of octyl palmitate (TEGOSOFT® OP, Goldschmidt GmbH), 27 g of C_{12/14}E₈, 12 g of water, 3 g of preservative (Euxyl® K 300, Schülke & Mayr (phenoxyethanol, methyl-, ethyl-, butyl-, propyl- and isobutylparaben)) and 3 g of trilaureth-4 phosphate (Hostaphat® KL 340 D, Clariant) were combined and stirred. An emulsion cloudy at room temperature was formed which, after a short time, separated into a two-phase system of the Winsor I type. Upon heating and stirring, above 70° C., a single phase, homogeneous and transparent microemulsion phase was formed, whose single-phase region (Winsor IV system) was in the temperature range between 70° C. and 85° C.

Step 2 (PIT Method):

The microemulsion phase was quenched in a water bath at room temperature. A homogeneous, transparent, finely divided O/W emulsion was formed.

The O/W emulsion obtained as in step 2 was diluted as in Example 2a to an oil/surfactant concentration of about 0.5%, and the droplet size was determined by means of dynamic light scattering. FIG. 2 shows that a broad distribution of the droplet radii was present between 50 nm and 490 nm with a maximum at 110 nm.

Microscopy:

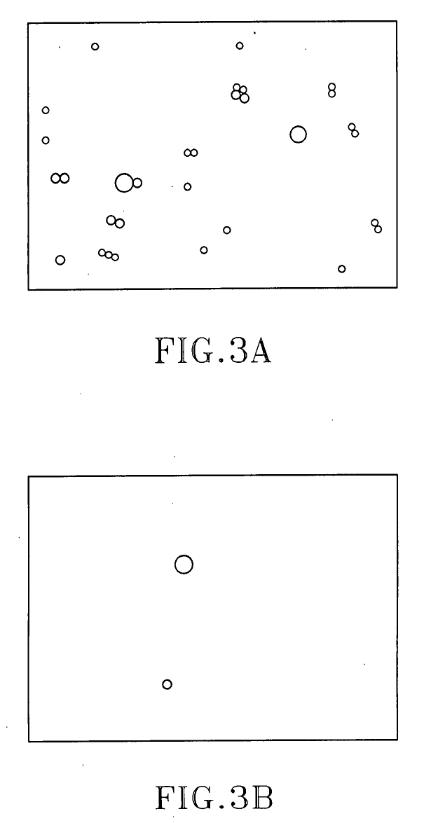

The finely divided O/W emulsions produced in step 2 of Examples 1 and 2 were viewed under the light microscope at 40× magnification. FIGS. 3A and 3B show that the emulsion produced by the PIT method as in Example 2b contained droplets in the submicrometer range besides air bubbles, whereas in the case of the emulsion produced by the PSQ method as in Example 2a, a homogeneous image arose because the droplet size was below the resolution of the microscope.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A method of producing finely divided oil-in-water emulsions which comprise oil, water and at least one emulsifier, which comprises a step
A) producing a mixture 2, which has oil, water, at least one emulsifier and at least one cosmotropic substance, by mixing oil, water, at least one emulsifier and at least one cosmotropic substance, where the phase inversion temperature PIT2 of this mixture (Winsor IV system) is less than the phase inversion temperature PIT1 of a mixture 1 (Winsor IV system) which has no cosmotropic substances and otherwise the same composition as mixture 2,
and subsequently a step
B) addition of a diluent to mixture 2 to convert this mixture to an emulsion 3, where the amount of added diluent is chosen so that the resulting emulsion 3 at a pregiven temperature is not in the Winsor IV phase region.

2. The method as claimed in claim 1, wherein an emulsion kinetically stable at ambient temperature, processing temperature or use temperature is produced as emulsion 3.

3. The method as claimed in claim 1, wherein the emulsion 3 has an average particle size of less than 1 μm.

4. The method as claimed in claim 1, wherein a microemulsion is produced as mixture 2.

5. The method as claimed in claim 1, wherein, in step B), the amount of diluent added is such that the transition temperature at which the emulsion 3 converts to the Winsor IV phase region is at least 1 K above the ambient temperature, the processing temperature or use temperature.

6. The method as claimed in claim 1, wherein, in step B), at least 1 part by mass of diluent is added to 1 part by mass of the mixture 2.

7. The method as claimed in claim 1, wherein the diluent used in step B) is water or an aqueous solution.

8. The method as claimed in claim 1, wherein an emulsion kinetically stable at ambient temperature, processing temperature or use temperature is produced as emulsion 3, where, in step A), a thermodynamically stable and macroscopically homogeneous mixture of water, oil, at least one emulsifier and at least one cosmotropic substance is produced by customary methods, and where step A) is carried out at a temperature which is lower than the phase inversion temperature PIT1 of the mixture 1 without addition of the cosmotropic substances.

9. The method as claimed in claim 1, where an emulsion kinetically stable at ambient temperature, processing temperature or use temperature is produced as emulsion 3, where step A) comprises the admixing of at least an amount of at least one cosmotropic substance to a mixture 1, which comprises oil, water and at least one emulsifier and which has a phase inversion temperature PIT1 (Winsor IV system), such that a mixture 2 is obtained whose phase inversion temperature (Winsor IV system) PIT2 is less than PIT1.

10. The method as claimed in claim 1, wherein an emulsion kinetically stable at ambient temperature, processing temperature or use temperature is produced as emulsion 3, where, in step A), water, oil, at least one emulsifier and at least one cosmotropic substance are used to produce a W/O microemulsion phase in equilibrium with excess water phase (type W II) by customary methods without exceeding the original phase inversion temperature.

11. The method as claimed in claim 1 further comprising formulating said emulsion 3 into one of a cosmetic preparation, a dermatological preparation, a pharmaceutical preparation and an agrochemical preparation.

12. The method as claimed in claim 1 further comprising formulating said emulsion into an impregnated wipe or a sprayable preparation for face care and body care, baby care, sun protection, make-up remover, and antiperspirants/deodorants.

13. The method as claimed in claim 1 further comprising formulating said emulsion 3 into an aqueous formulation for applications in areas of household, sports, leisure and industry.

14. The method as claimed in claim 1 further comprising formulating said emulsion 3 into an impregnated wipe or a sprayable preparation for the cleaning and care of textiles, leather, plastics, metallic and nonmetallic surfaces.

15. The method as claimed in claim 1 further comprising oils and optionally further active substances.

16. A finely divided oil-in-water emulsion obtainable by a method as claimed in claim 1.

17. The emulsion as claimed in claim 16, which has a particle size of less than 1 μm.
